(19) United States
(12) Patent Application Publication
(10) Pub. No.: US 2020/0234297 A1
(43) Pub. Date: Jul. 23, 2020

(54) Cognitive Approval of Transactions Based on Unique Multi-Device Signatures

(71) Applicant: International Business Machines Corporation, Armonk, NY (US)

(72) Inventors: Cody Murray, Scotia, NY (US); Alex R. Hubbard, Rensselaer, NY (US); Richard C. Johnson, Selkirk, NY (US)

(21) Appl. No.: 16/253,628

(22) Filed: Jan. 22, 2019

(51) Int. Cl. G06Q 20/40; G06N 20/00; G06Q 20/32

(52) U.S. Cl. CPC G06Q 20/40; G06Q 20/3224; G06Q 20/3278; G06N 20/00

(57) ABSTRACT

Transaction verification mechanisms are provided that receive transaction information, from a computing device at a transaction location, including user device information specifying one or more user device identifiers associated with a user initiating a transaction, vendor device information specifying a plurality of vendor device identifiers in a near field area associated with the computing device, and account information for an account being used to perform the transaction. A user device verification is performed on the one or more user device identifiers and a vendor device verification of the plurality of vendor device identifiers is performed to verify the transaction location as being an authorized vendor location. A determination whether to approve/deny completion of the transaction at the computing device is performed based on results of the user device verification and the vendor device verification and an output is sent to the computing device based on the determination.

### BACKGROUND

The present application relates generally to an improved data processing apparatus and method and more specifically to mechanisms for providing cognitive approval of transactions based on unique multi-device signatures.

Identity theft is a major issue in modern society, especially with the proliferation of electronic transactions as a basis for commerce. Identity theft is the act of an individual stealing personal information and using that personal information to assume the identity of the person whose information is stolen, specifically for purposes of opening accounts, filing falsified tax returns, renting or buying property, making financial transactions using credit card numbers or account numbers, or performing any of a number of other criminal activities.

Many modern services have been created to attempt to combat identity theft by catching instances of such identity theft after the thief has successfully or unsuccessfully attempted to utilize the surreptitiously obtained personal information of another. For example, services such as LifeLock™, provide consumers with the ability monitor their accounts for indication of transactions that are suspicious and flagging them for confirmation. Similarly, credit card companies run algorithms on transaction patterns to identify patterns indicative of suspicious activity so that they may notify their customers. However, such solutions are reactive rather than proactive in nature.

Some recent solutions provide a single factor confirmation before a transaction can be completed, e.g., by requiring a user to confirm a transaction via a separate device before allowing the transaction to be completed. For example, with some accounts, a user is sent a text message to which they must respond or are required to enter a particular code into a computing device or mobile device in order to confirm that the transaction should be completed. However, such mechanisms may be thwarted by sophisticated identity thieves if consumers are not wary.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising at least one processor and at least one memory, wherein the at least one memory comprises instructions that are executed by the at least one processor to cause the at least one processor to be specifically configured to implement a transaction verification system. The method comprises receiving, by the transaction verification system, transaction information from a computing device at a transaction location. The transaction information comprises user device information specifying one or more user device identifiers associated with a user initiating a transaction, vendor device information specifying a plurality of vendor device identifiers in a near field area associated with the computing device, and account information for an account being used to perform the transaction. The method further comprises performing, by the transaction verification system, a user device verification of the one or more user device identifiers as being associated with an authorized user of the account. Moreover, the method comprises performing, by the transaction verification system, a vendor device verification of the plurality of vendor device identifiers to verify the transaction location as being an authorized vendor location with which the account may be utilized. In addition, the method comprises determining, by the transaction verification system, whether to approve or deny completion of the transaction at the computing device based on results of the user device verification and the vendor device verification. The method also comprises sending, by the transaction verification system, an output to the computing device based on the determination whether to approve or deny completion of the transaction.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 illustrates a functional block diagram of an example transaction verification system in accordance with one illustrative embodiment;

FIG. 2 is a flowchart outlining an example overall operation for transaction verification in accordance with one illustrative embodiment;

FIG. 3 is a block diagram of just one example data processing system in which aspects of the illustrative embodiments may be implemented;

FIG. 4 is an example diagram illustrating a cloud computing environment in which aspects of the illustrative embodiments may be implemented; and

FIG. 5 is an example diagram illustrating a set of functional abstraction layers provided by cloud computing environment in which aspects of the illustrative embodiments may be implemented.

### DETAILED DESCRIPTION

As mentioned above, identity theft and the ability to verify the identity of a person attempting to utilize personal information, e.g., financial account information, credit card information, etc. is an important issue in modern electronic transaction environments. In providing a more secure mechanism for verifying the identity of a person attempting to utilize personal information of an authorized person, e.g., the authorized person's credit card information, account information, personal identity indicator such as a driver's license number, social security number, or the like, a multi-factor verification mechanism has been devised and described in co-pending and commonly assigned U.S. patent application Ser. No. 15/651,555, filed Jul. 17, 2017, and entitled “Identity Validation Using Local Environment Information,” which is hereby incorporated by reference. With the mechanism described in this co-pending and commonly assigned application, a plurality of the authorized user's registered mobile devices are verified as being present at the physical location where the transaction is being performed or initiated, potentially with a weighting mechanism being utilized to weight different mobile device identities relative to others, where the weights are determined based on different criteria depending on the desired implementation. For example, a user's mobile phone identity, fitness tracker identity, smart watch identity, and/or the like, may be verified in combination with one another, along with credit card or account information, in order to verify that the user is a verified user of the credit card or account that is being used to complete a transaction. The combination of specific identifiers of devices associated with the user represents a unique user signature which is the basis of a fuzzy logic or cognitive computing evaluation of the likelihood that the user is the authorized person associated with the credit card or account information.

It has been recognized that while verification of the user's identity may be improved via a multi-factor verification mechanism, such as described in this co-pending patent application, it is also important in some instances to be able to verify the vendor and the goods/services that are the subject of the transaction. That is, it is also important to ensure that the verified user is permitted to utilize the personal information to engage in the specific transaction with that particular vendor and for the purpose of obtaining the particular goods/services. For example, there are instances where a guardian person, organization, or other guardian entity wants or must exercise greater control over the use of a dependent person's information, e.g., credit cards, accounts, etc., e.g., a guardian of a dependent person, such as a parent/child relationship, a child/elderly parent relationship, a trustee/beneficiary relationship, or any other relationship where one party has authority to control the use of personal information of another person. In some cases, such relationships may be extended to include government organizations and beneficiaries of the funds/services of those government organizations.

For example, a parent or guardian may wish to provide funds for a dependent child's use for particular purposes, e.g., a parent providing a credit card to a child for use in purchasing fuel for their vehicle, groceries at grocery stores, etc., and yet not to be used for other purposes, e.g., purchasing alcohol, tobacco, junk food, toys/games, movies/entertainment, etc. Moreover, the parent or guardian may wish to control the types of vendors that the dependent may perform transactions with, as well as the amounts spent on certain products/services, such as for purposes of budgeting. The same is true of children with elderly parents, or any dependent elderly person, where the elderly parent may have access to their own accounts/funds and may utilize them at various vendors for various products/services. As many unscrupulous people target the elderly, protections are important to ensure that the elderly person, even though verified, is not able to engage in transactions with vendors or for goods/services that are not approved by the corresponding guardian.

Currently, there are no viable mechanisms available for guaranteeing that the dependent will utilize their funds, accounts, etc. for the intended purpose and/or at an approved vendor. The single factor verification mechanisms as discussed above are able to be thwarted by sophisticated thieves and may have significant time delays that may not be adequate for transactions being conducted at a point of sale terminal. Moreover, such single factor verification mechanisms only verify the identity of person engaging in the transaction. They do not verify the vendor and do not verify that the products/services that are the subject of the transaction are approved by a guardian or provider of funds/accounts. For example, using such single factor verification, a child could verify who they are via their mobile telephone and a corresponding application, and yet still be able to complete a transaction at a vendor not approved by their guardian and obtain products/services that are not approved by the guardian, e.g., purchasing tobacco products at a convenience store when the account was established for fuel purchases at gas stations.

It would be beneficial to have a mechanism that not only verifies the identity of the user via a multi-factor verification mechanism, such as described in the co-pending patent application mentioned above, but also verify the identity of the vendor with which the transaction is being conducted and the goods/services that are the subject of the transaction. Moreover, it would be beneficial to provide such a mechanism where the verification is performed in a manner that is difficult for an unauthorized person to circumvent or spoof. With such a mechanism, the user is verified to be who they claim to be, the vendor is verified as being who they claim to be and as being an approved vendor with which the user is permitted to engage in a transaction, and the goods/services that are the subject of the transaction are verified as being goods/services that the user is permitted to obtain via the transaction, in accordance with the wishes of the guardian of the user.

With the mechanisms of the illustrative embodiments, a guardian/parent may establish or otherwise control an account, obtain a pre-paid credit card, a regular credit card account with associated credit card limit, or any other type of source of funds on behalf of a dependent, such as a child, elderly parent, or any other person or organization over which the guardian/parent has control over the use of the funds associated with the account. In establishing the account, the guardian/parent (hereafter referred to simply as the guardian) may establish account controls specifying the particular purpose for which the funds associated with the account may be utilized, and may even specify particular approved vendors with which the account may be utilized if desired. In some illustrative embodiments, such controls may further set forth limitations of the particular vendor locations with which the funds or account may be utilized, e.g., controls specifying a geographical region or regions in which the vendor locations may be located, time of day restrictions, or any other controls that may specify the way in which the funds may be utilized with regard to the vendors, vendor locations, characteristics of the transactions, and the purpose for which the transactions are being performed. Moreover, in accordance with the mechanisms described in the co-pending U.S. patent application Ser. No. 15/651,555 noted above, the dependent or beneficiary may register their various wearable, portable, or other Internet of Things (IoT) devices with the mechanisms of the illustrative embodiments as a basis for verifying the dependent or beneficiary. These controls may be utilized as a basis for verifying transactions associated with the account by verifying the user, verifying the vendor, and verifying the products/services, as described in greater detail hereafter.

In addition to registering the guardian's account for the dependent or beneficiaries use, the vendors also register their unique identities with the mechanisms of the illustrative embodiments. The unique identifier of a vendor may be based on a combination of unique identifiers of devices present within the physical location of the vendor. For example, the vendor may have multiple point-of-sale (POS) devices, computing devices, and the like, present within the vendor's location with each POS device having its own unique identifier, e.g., a Media Access Control (MAC) address, Internet Protocol (IP) address, or other unique identifier of the particular device. The combination of device unique identifiers uniquely identifies the vendor and/or vendor location. In some instances, a particular vendor may have multiple locations and the unique combination of addresses of devices at a particular vendor location identifies that vendor location differently than other vendor locations associated with the same vendor.

For example, at a first vendor location, POS devices may be present that have unique identifiers POS1, POS2, and POS3, as well as network router NR1, server S1, etc. The combination of these unique identifiers uniquely identifies the vendor and/or vendor location, as anyone attempting to adopt the identity of the vendor or vendor location would need to have all, or at least a sufficient number, weighted and evaluated according to fuzzy matching logic, in order to circumvent verification. In addition, other characteristics of the vendor/vendor location, such as global positioning system (GPS) location, may be used to augment the verification based on the unique identifiers. In addition, other cryptographic mechanisms may be utilized to protect the unique identifiers from being able to be adopted or spoofed by an unauthorized party, e.g., the vendor may establish a cryptographic key or the like that may be applied to a correct combination of unique identifiers of devices at the vendor or vendor location in order to generate a value that identifies the vendor or vendor location.

In addition to the vendor identification information being registered, the vendor also registers information specifying the types of goods/services that are available for purchase via transactions with the vendor at the vendor location. These types of goods/services may be selected from a predefined listing of general categories of goods/services (e.g., food, alcohol, tobacco, entertainment media, etc.), selection of specific identifiers of specific goods/services available for purchase (e.g., bread, deli meats, cheese, candy, beer, cigarettes, etc.), or the like. The identification of the types of goods/services may be used as an additional verification mechanism for verifying the transactions by checking to determine whether the vendor or vendor location provides goods/services that are approved by the guardian as goods/services for which the funds/account may be utilized, as specified in the account controls in the account registry.

Thus, a registry of account information and controls is generated along with an associated user identification registry that identifies the particular combination of IoT device identifiers that uniquely identify a user. In addition, a registry of vendors and/or vendor locations is generated. Thus, when a transaction is attempted, the transaction information is transmitted to a transaction verification computing system of the illustrative embodiments that comprises these registries. This transaction information includes the account information that is attempting to be utilized, e.g., credit/debit card account number, banking account information, or the like, as well as unique identifiers of the POS devices, computing devices, networking devices, etc., and IoT devices currently present in the vicinity of the transaction source, e.g., the IoT devices associated with the user as well as the vendor's devices present in the vendor location.

As part of the verification process, the transaction verification computing system compares the IoT device identifiers received as part of the transaction information to the registered IoT device information for the authorized users of the account. For example, the credit/debit card account number information in the transaction information may be used to retrieve the corresponding account information and user information from the registries. The IoT device identifiers obtained in the transaction information may be compared to registered IoT device identifiers associated with an authorized user of the account to verify that the person attempting to engage in the transaction is indeed an authorized user. An evaluation of the IoT devices may involve a cognitive evaluation of the various IoT devices using weightings and the like, to determine a probability value or confidence value indicative of a confidence or probability that the person initiating the transaction is in fact an authorized user of the account. If the probability or confidence value is sufficiently high, e.g., higher than a predetermined threshold, then it may be determined that the person initiating the transaction is an authorized user of the account.

In addition, the verification process further includes a verification of the vendor or vendor location based on the POS device identifiers and/or other computing device, network device, or other IoT device identifiers associated with the vendor or vendor location. The verification of the vendor or vendor location based on the unique identifiers of the POS devices, computing devices, network devices, and other IoT devices associated with the vendor/vendor location may be performed in a similar manner to that of the verification of the individual user. That is, the transaction information may specify a vendor identity or vendor location identity which may be used to perform a lookup of the vendor's unique device identifiers associated with that vendor or vendor location (hereafter simply referred to as the vendor, but it should be kept in mind that the mechanisms may be used to identify individual vendor locations associated with the same vendor). The combination of POS device identifiers, computing device identifiers, network device identifiers, or other IoT device identifiers sent in the transaction information may be compared to the registered identifiers for the vendor to verify the identity of the vendor. In this way, both the user and the vendor are verified as being authorized parties to the transaction.

The verification of the vendor's identity not only is used to ensure that the transaction is occurring at the registered vendor's location, but is also used to verify that the vendor where the transaction is initiated, is a vendor that is approved of by the guardian as specified in the account controls. That is, the guardian may establish a listing of approved vendors with which the account may be utilized. In such a case, in addition to verifying the identity of the vendor, the vendor may be compared to approved vendors associated with the account to ensure that the vendor is an approved vendor for the account.

Additional verifications of the transaction may be performed based on the characteristics of the transaction and the account controls established by the guardian and specified in the control information associated with the account in the account registry. For example, the identification of types of goods/services provided by the vendor may be verified against the controls specified for the account to ensure that the vendor sells goods/services of a type for which the guardian has provided approvals that the account may be used. This is a coarse grain verification that may operate as a first level of goods/services verification or may be used as the primary goods/services verification in implementations where a more rapid verification is required or desired. A more detailed verification may also be performed, in some implementations, where individual identifiers of the goods/services attempting to be purchased as part of the transaction may be verified against these controls at an individual good/service granularity. If the type of goods/services, or potentially an individual good/service, does not fall within the approved goods/services for which the account may be utilized, as specified by the account controls information, then the transaction may be denied.

Thus, as part of this verification process, if the user is determined to not be, or have a relatively low probability or confidence of being, an authorized user of the account based on their current set of IoT devices associated with them at the vendor's location, the transaction may be denied, and an appropriate notification sent to the account provider, e.g., credit card company, bank, or other authorized person/organization, and potentially the guardian/authorized user indicating the reason for the denial. Similarly, if the vendor is determined to not be, or have a relatively low probability or confidence of being, an authorized vendor based on the current set of devices present at the vendor location where the transaction is initiated, then the transaction may be denied, and an appropriate notification sent to the account provider and potentially the guardian/authorized user indicating the reason for the denial. Moreover, if the vendor is verified, but is not an approved vendor for which the account may be used, as specified by account control information, then the transaction may be denied and the appropriate notification sent. Furthermore, if the type of goods/services provided by the vendor, or the specific goods/services that are the subject of the transaction, are not approved goods/services for which the account may be utilized, then the transaction may also be denied and an appropriate notification sent. Hence, a multi-factor verification process is employed by the mechanisms of the illustrative embodiments to ensure that not only are the parties to the transaction, i.e. the user and the vendor, who they claim to be, but also that the parties are approved by the guardian for use with the account, and that the goods/services are goods/services for which the account may be used.

To illustrate the operation of the mechanisms in a more anecdotal manner, consider a parent that establishes a pre-paid credit/debit card for their dependent child. The guardian may, when establishing the credit/debit card account, specify that the funds in the account can only be used to purchase fuel at gas stations present within the geographical area of Dallas, Tex. In some cases, the guardian may specify a particular vendor with which the credit/debit card account may be utilized, e.g., ABC Fuel Stores. Moreover, the guardian may specify that each transaction may not exceed a dollar amount of $50.00. In addition, the child's IoT devices are registered with the user registry to identify the particular IoT devices that are associated with that child, e.g., their mobile phone, their fitness tracker device, their smart watch, etc.

Now, assume that the child goes into a vendor and uses the pre-paid credit/debit card to purchase goods/services. The child presents the corresponding pre-paid credit/debit card, or otherwise provides the account information for entry, at the POS device. The account information is combined with the other transaction information, i.e. vendor identification, vendor device identifiers, user device identifiers, and potentially the goods/services being purchased, to generate the transaction information that is transmitted over one or more data networks to the transaction verification system of the illustrative embodiments. In one example scenario, assume that the child is attempting to purchase fuel from a gas station vendor and has their registered mobile phone and fitness tracker on their person at the time that the transaction is initiated.

In response to the transaction being initiated, the POS device may wirelessly interrogate, such as via a short range wireless communication protocol (e.g., Bluetooth or the like), the IoT devices present on the child to obtain their unique identifiers, potentially encrypted using any established encryption mechanism to ensure that a third party does not intercept the personal information of the child's IoT device identifiers. The unique identifiers of the child's mobile phone and fitness tracker are returned and added to the transaction information. In addition, the wireless interrogation may further include interrogating local POS devices, computing devices, network devices, or other IoT devices present in the vendor location where the transaction is initiated, which may likewise return their corresponding unique identifiers which may be added to the transaction information. Alternatively, the vendor location's computing system, through which the POS device transactions are routed, may add the vendor location's device identifiers to all transactions being routed through it to the transaction verification computing system as a pre-set vendor identification signature. In some embodiments, the identification of the goods/services being purchased as part of the transaction are also included in the transaction information, e.g., fuel in this case, along with the total amount of the transaction.

The transaction information is received at the transaction verification computing system which compares the user's IoT device identifiers in the transaction information to the registered user's IoT device identifiers to ensure that the user is the authorized user of the pre-paid credit/debit card account, i.e. the user is the child for which the pre-paid credit/debit card account was provided. Thus, for example, if the mobile phone and fitness tracker identifiers present in the transaction information match the mobile phone and fitness tracker identifiers that are registered as being associated with the child, then the user may be confidently determined to be the child for which the pre-paid credit/debit card account was established.

The transaction information further is used to verify that the source of the transaction information is a registered vendor based on the particular vendor signature or combination of unique identifiers of POS devices, computing devices, network devices, or other IoT devices present at the vendor location where the transaction originates. That is, the vendor and/or vendor location may be pre-registered with the transaction verification computing system as an authorized vendor/vendor location and corresponding unique identifiers of devices physically present at the vendor's location may be registered in association with that vendor/vendor location. The vendor device identifiers, or vendor signature, in the transaction information may then be compared against this registered vendor device identifier information for the vendor/vendor location the transaction alleges the transaction is from, to determine a confidence or probability that the transaction is originating from an authorized vendor and/or vendor location. Assuming that the vendor/vendor location is a pre-registered authorized vendor, and the vendor device information in the transaction information provides a sufficiently high probability or confidence that the transaction is originating with that vendor/vendor location, the corresponding vendor/vendor location information may then be retrieved, identifying what types of goods/services the vendor/vendor location provides.

For example, in this example scenario, assume that the child has attempted to pay for a purchase of fuel from a POS device having POS device identifier POS1 at the vendor location ABC Fuel Stores. The other POS devices, e.g., POS2, POS3, and computing device CP1, are identified as being present at the vendor location and their identifiers are added to the transaction information. Moreover, ABC Fuel Stores has pre-registered this vendor location as having the device identifiers POS1, POS2, POS3, and CP1. The transaction information identifies the source of the transaction as being ABC Fuel Stores and includes the device identifiers POS1, POS2, POS3, and CP1. The transaction verification computing system of the illustrative embodiments performs a lookup operation in the vendor registration database and determines that ABC Fuel Stores is an authorized vendor and that the device identifiers POS1, POS2, POS3, and CP1 are in fact valid identifiers of the particular registered ABC Fuel Stores location that is the source of the transaction. Thus, the user has been verified and the vendor location has been verified in this scenario.

The transaction information is further used to verify that the vendor sells goods/services that the pre-paid credit/debit card account is permitted to be used to purchase. This verification may be a coarse grain verification of the types of goods/services sold by the vendor against the types of goods/services for which the pre-paid credit/debit card account may be used, e.g., fuel in this scenario. Thus, in such a verification, it may be determined from the vendor information retrieved from the vendor registration database that the vendor sells fuel and that the child's pre-paid credit/debit card account has been approved for purchasing fuel. In such a case, the transaction may be verified as being directed to an approved purchase. In some embodiments, a more fine grain evaluation of the particular goods/services may be implemented to identify whether or not each good/service that is the subject of the transaction falls into a category for which the guardian has given approval that the pre-paid credit/debit card account may be utilized.

Thus, in this scenario, since the child is purchasing fuel from an authorized vendor, and both the child and the vendor have been verified, the transaction may be approved. A final verification may be made based on the total amount of the transaction to ensure that monetary amount limits are not exceeded, e.g., the monetary limit in this case is $50.00 and thus, assuming the transaction is $50.00 or less, the transaction will be verified. Hence, since the user of the pre-paid credit/debit card account has been verified to be an authorized user via a multi-factor verification of authorized user IoT devices, is using the pre-paid credit/debit card account at a vendor that is authorized and the transaction originates from a source that is verified as being the authorized vendor via a multi-factor verification of vendor devices, and the user is using the pre-paid credit/debit card account for an authorized purpose as determined by a verification of the goods/services provided by the vendor and the account controls established by the guardian, and is for an amount equal to or less than any established monetary limits, the transaction is approved and allowed to complete at the POS device.

It should be appreciated that if any of these verifications were to fail, the transaction may be denied or rejected by the transaction verification computing system and appropriate notifications generated and output to computing/communication devices to inform appropriate parties of the potential mis-use of the account. Moreover, in some illustrative embodiments, appropriate notifications may be generated and output to appropriate parties via their computing/communication devices even in the case where the transaction is approved, so as to keep informed the appropriate parties as to the way that the account is being used by the dependent, e.g., informing the parent of how the child is using the account.

As described above, the mechanisms of the illustrative embodiments may be used as a basis for controlling the way in which a dependent utilizes funds or an account that is established on their behalf by a guardian. However, the illustrative embodiments are not limited to such. Rather, the mechanisms of the illustrative embodiments may be extended to any arrangement in which one party controls the way in which another party utilizes the financial information, accounts, funds, etc. For example, a governmental organization that provides governmental assistance to beneficiaries of the government assistance may utilize the mechanisms of the illustrative embodiments to enforce controls on the way the beneficiary may utilize the government assistance with regard to the vendors and goods/services that may be involved in transactions using the government assistance. The mechanisms of the illustrative embodiments may provide a multi-factor verification of the user, a multi-factor verification of the vendor, and a verification of the goods/services that are the subject of the transaction, in order to ensure that all the parties involved and the goods/services involved in a transaction meet the purposes of the government assistance program.

Furthermore, while the primary illustrative embodiments described above may be used to control the way in which financial information and funds may be utilized to complete transactions for goods/services, the illustrative embodiments are not limited to such. In other illustrative embodiments, the mechanisms may be used to control, by the guardian, the utilization of any personal information associated with the dependent. For example, a guardian may set forth specific controls over how the dependent may utilize their personal information such as social security number, health information, or the like. For example, the controls may specify that the user's social security number cannot be used to obtain a driver's license, such as in the case of an elderly parent that no longer drives. Many times, unauthorized users may attempt to steal the identity of an elderly person to obtain a valid driver's license when the elderly person does not themselves hold a valid driver's license. The mechanisms of the illustrative embodiments may be utilized to prevent such identity theft by requiring verification of the user via a multi-factor verification, verification of the vendor via a multi-factor verification, and verification that the personal information is being utilized for a purpose approved of by the controls associated with the personal information as established by the guardian. It can be seen that other controls over personal information may be enforced by the mechanisms of the illustrative embodiments in view of the present description without departing from the spirit and scope of the present invention.

Having summarized elements of various illustrative embodiments above, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

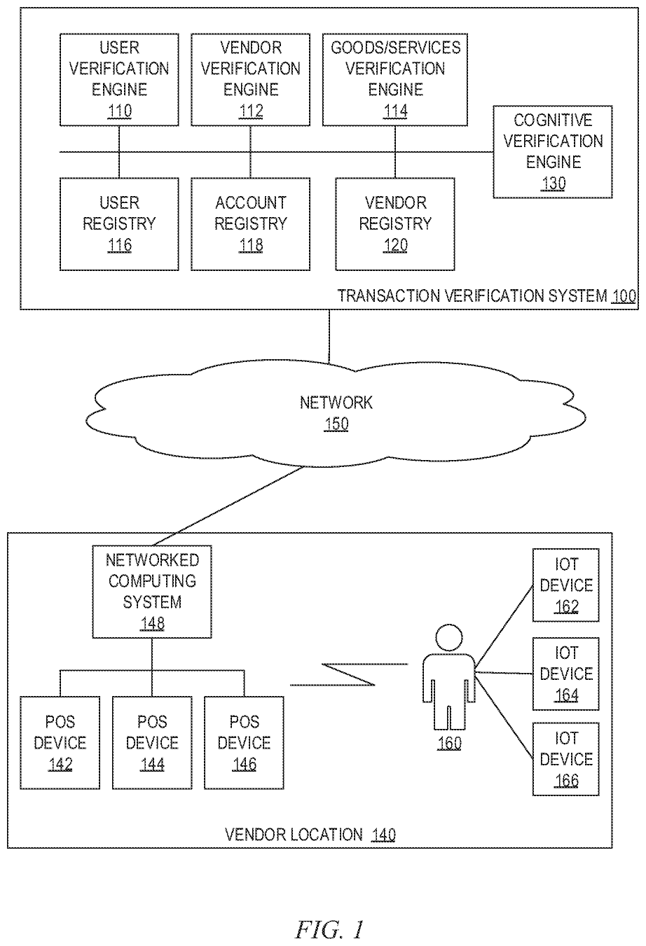

FIG. 1 illustrates a functional block diagram of an example transaction verification system in accordance with one illustrative embodiment. The transaction verification system may be associated with an account provider that provides an account for use by a dependent individual under the control of a guardian individual or entity. The account provider may be a financial institution, a government agency or organization, a municipality, or any other provider of an account which may comprise funds, personal information, or the like, that may be used by a dependent individual for purposes controlled by controls established by a guardian. In the depicted example, for purposes of illustration, it is assumed that the dependent is a child (dependent) who has been given a credit card by a parent (guardian) for a specific use, e.g., purchasing fuel for the child's vehicle. While this example will be used herein to illustrate the features of the present invention, it should be appreciated that this is only one example of how the mechanisms of the illustrative embodiments may be applied. Other implementations of the mechanisms of the illustrative embodiments to verify the use of personal information associated with a dependent, under controls established by a guardian, as will be readily recognized by those of ordinary skill in the art in view of the present description, are intended to be within the spirit and scope of the present invention.

As shown in FIG. 1, the transaction verification system 100 comprises user verification engine 110, vendor verification engine 112, and goods/services verification engine 114 along with supporting registries or libraries 116-120. The supporting registries/libraries 116-120 include a user registry or library 116, an account registry or library 118, and a vendor registry or library 120. These registries/libraries 116-120 may be provided as part of one or more database systems comprising data storage and corresponding logic for storing and accessing data present in these registries/libraries 116-120. The transaction verification system 100 may have a cognitive verification engine 130 that evaluates received transaction information against information provided in the various registries or libraries 116-120 to determine a likelihood or probability that a user is an authorized user, a vendor is an authorized vendor, and the goods/services are goods/services that are authorized for purchase via a registered account that is being used as part of a transaction. The transaction verification system 100 may be provided as part of a cloud computing system or service and thus, may be implemented using one or more computing devices, e.g., server computing systems, database systems, or the like.

The transaction verification system 100 operates on transaction information received from one or more computing devices associated with one or more different vendors and/or vendor locations, such as vendor location 140. For example, in one illustrative embodiment, point-of-sale (POS) devices 142, 144, and 146 may be coupled to one or more data networks 150 either directly or through a networked computing device 148 associated with the vendor location 140. It should be appreciated that other computing devices, such as network switches, routers, and the like, may be part of the configuration of the computing devices at the vendor location 140 but are not specifically illustrated in FIG. 1 for simplicity. Each of the computing devices 142-148 present at the vendor location 140 may be registered with the transaction verification system 100 with one or more corresponding data entries being generated in the vendor registry or library 120 specifying the combination of computing devices 142-148, the vendor location 140, as well as goods/services available at the vendor location 140.

The transaction information may be collected at the vendor location 140 computing device, such as POS 146, in response to the initiation of a verification event (e.g., a transaction). For example, in response to the initiation of a purchase the POS 146, such as the scanning of bar codes or otherwise entry of identifiers of goods/services that are being purchased as part of a transaction, collection of information for inclusion in the transaction information sent to the transaction verification system 100 may begin to be collected by the POS device or system 146. For example, the goods/service identifier information may be collected as the POS device 146 is being used to enter each identifier of the goods/services. The identities of the other devices present in the vendor location 140, e.g., the networked computing device 148, the other POS devices 142-144, and the like, may be gathered based on a short range wireless communication (e.g., Bluetooth or Wi-Fi) or wired communication channel (e.g., Ethernet) with these other computing devices.

In some illustrative embodiments, the POS device 146 may use a short range wireless communication channel, e.g., a Bluetooth communication, Wi-Fi communication, or the like, to also identify computing and/or communication devices 162-166 associated with a user 160 as being within a predetermined short range area (e.g., a radius of inches, feet, a yard, etc.) of the POS device 146. For example, the POS device 146 may send a wireless interrogation signal to the personal devices 162-166, e.g., mobile telephone, smart watch, fitness tracker, etc., of the user 160 which may then respond with their corresponding identifiers, which may be provided in an encrypted manner in some illustrative embodiments. The device identifiers, e.g., MAC addresses, Service Set Identifiers (SSIDs), or other unique device identifiers, from the personal devices 162-166 associated with the user 160 may be included in the transaction information along with the vendor device identifiers of the devices 142-148 present in the vendor location 140, and the identification of the goods/services that are the subject of the transaction as collected by the POS device 146. This information together may be considered the transaction information that is transmitted via the data network 150 to the transaction verification system 100 for verification.

As mentioned previously, rather than having to interrogate each of the other vendor devices 142-148 present in the vendor location 140 for each transaction, the vendor location signature comprising the combination of individual vendor device identifiers of the devices 142-148 present in the vendor location 140 may be pre-stored as a vendor location signature which may be added to each set of transaction information transmitted to the transaction verification system 100. This vendor location signature may be stored by the networked computing devices 148, for example, through which the transactions are routed to be transmitted to the transaction verification system 100. It should be appreciated that in some illustrative embodiments, this vendor location signature may be updated periodically to reflect the current operational status of the devices 142-148 in the vendor location 140. For example, if a POS device 142 becomes inoperable at a particular point in time, then the updated vendor location signature at that point in time may comprise only the identifiers of the other devices, e.g., devices 144-148. If at a later time the POS device 142 becomes operable again, and if another of the POS devices 144 becomes inoperable, then the updated vendor location signature may comprise only the identifiers of the devices 142 and 146-148. Thus, the networked computing device 148 may store the most recent vendor location signature as determined on a periodic basis, which may then be added to the transaction information generated that the POS devices 142-146 when engaging in transactions with users.

The transaction information from the POS device 146 is sent to the transaction verification system 100, either directly or via a networked computing device 148, for verification of the transaction information before approving completion of the transaction at the POS device 146 with the user 160. The transaction verification system 100 verifies, in some embodiments as a parallel set of processes, the user device identification information from user devices 162-166, the vendor and vendor information from the vendor devices 142-148, and the goods/services information present in the transaction information received. The cognitive verification engine 130 performs a cognitive evaluation of the results of these verifications to determine whether or not to approve/deny the transaction and returns a corresponding responsive message to the source of the transaction information, e.g., POS device 146.

The user verification engine 110, vendor verification engine 112, and goods/service verification engine 114 of the transaction verification system 100 employs logic for performing a weighted evaluation and probability determination as to whether or not the corresponding elements being verified should be verified as being associated with an authorized/approved transaction. These engines 110-114 in some illustrative embodiments implement a fuzzy logic or weighted evaluation logic to weight the various information and determine a probability or score indicative of whether the particular element (user, vendor, goods/services) is authorized or verified. This probability or score may be compared against a threshold indicating a minimum level of confidence required to return a result that the corresponding element is authorized or verified, e.g., a 80% probability or confidence. In some illustrative embodiments, these engines 110-114 implement a neural network that is trained to evaluate the various information associated with the corresponding element to thereby come to a cognitive determination as to the authenticity or verification of the element.

For example, the POS device 146 may have identified a smartphone (device 162), a Bluetooth headset (device 164), and a smart watch (device 166) as being present with the user 160 at the vendor location 140 when the transaction was initiated. This identification information may be transmitted to the transaction verification system 100 as part of the transaction information along with an indication of the account being used to complete the transaction, e.g., the credit/debit card number, account number, or the like. The user verification engine 110 may perform a look-up of the account information in the account registry 118 and retrieve the corresponding account information which may include authorized user identities and controls associated with the account, e.g., which types of vendors, or specific vendor identities, the account can be used with, geographical restrictions, monetary amount restrictions, types of goods/services restrictions, etc. The identity of the authorized user(s) of the account may be used to perform a lookup operation in the user registry 116 to retrieve the authorized user(s) device information (alternatively, the user registry 116 information for the user may be stored in the account registry 118 entry to reduce the number of lookup operations that are performed).

Each device (e.g., the smartphone, Bluetooth headset, and smart watch) may have an associated weight in the user's information retrieved from the user registry 116. The user verification engine 110, using the weight thresholds or the like, evaluates the associated weights of the devices with the user's information from the user registry 116. The weights may be learned through a machine learning process and associated with the different devices of the user and may be specific to the particular user or may be generalized for a plurality of different users. In some embodiments, the logic of the user verification engine 110 may be implemented in the POS device 146 or networked computing device 148 at the vendor location 140. In such embodiments, the POS device 146 or networked computing device 148 may determine if a predetermined threshold was met or not met based on the application of the logic of the user verification engine 110 and may then determine if the verification event (transaction) should be further processed, e.g., verifying the vendor and goods/services via the transaction verification system 100.

In some embodiments, rather than having the weights specified in the user information obtained from the user registry 116, for example, in embodiments where trained neural networks or other cognitive logic are used to implement the engines 110-114, the weights are learned operational parameters of the engines 110-114, e.g., learned weights associated with nodes of layers of the neural networks. It should be appreciated that in such embodiments, the user registry may be used to match the received user device identifier information in the transaction information to valid device information associated with the authorized user of the account, while the neural network applies the various weights to the matched/mismatched device information and any other user characteristics in order to cognitively determine a probability or confidence that the user 160 is an authorized user of the account that is being used as part of the transaction.

Thus, for example, in one illustrative embodiment, the matching device information from the user registry 116 is used to combine associated weights to generate a score, e.g., there may be a weight of 50 associated with the user's mobile phone, a weight of 10 associated with the user's Bluetooth headset, and a weight of 30 associated with the user's smart watch, which if all are matched with the user device information in the transaction information, provides a score of 90. This score may then be compared against a threshold value of, for example, 80 which indicates that the user 160 is likely the authorized user of the account. Similarly, using a neural network based evaluation, the user verification logic may compare the received user device information in the transaction information to the registered devices for the authorized user and based on the matching/mismatching, and weights associated with corresponding nodes in the neural network, may generate a probability value or confidence score indicating a level of confidence or probability that the user 160 is the authorized user, e.g., a 90% probability, which can then be compared to a threshold probability or confidence score value to determine whether the user 160 is likely the authorized user.

It should be appreciated that there may be other devices within a Near Field Communication (NFC) (e.g., a radio, such as a Bluetooth device, WiFi, etc.) range of the POS device 146 that are not associated with the user 160. For example, the POS device 146 may clearly identify the smartphone 162 owned by the user 160 as being within the NFC area (e.g., 2 inches), however a smart watch owned by a store clerk operating the POS device 146 may also be identified in the NFC area. This information may be included in the transaction information as well, but may be filtered out by the transaction verification system 100 in its cognitive evaluation of the device identifiers. For example, only those devices present in the NFC that also match device identifiers registered in the authorized users information in the user registry 116 may be further evaluated by the various engines 110-114. In this way, noise may be removed from the transaction information when performing the verification.

A similar evaluation may be performed on the vendor information in the transaction information using the vendor verification engine 112 and the vendor registry 120. That is, the vendor devices 142-148 may be evaluated in a similar manner as the user devices 162-166, against registered vendor devices specified in the vendor registry 120. A lookup operation may be performed by the vendor verification engine 112 based on the identity of the vendor specified in the transaction information to thereby retrieve the vendor device information for that vendor, which can then be matched with the vendor device information included in the transaction information. A weighted and/or cognitive evaluation of the matching vendor device information may be used to determine a likelihood that the source of the transaction information is in fact an authorized vendor.

In addition, the vendor verification engine 112 may verify whether or not the vendor is an authorized vendor with which the account being used as part of the transaction. This evaluation may also be a weighted, fuzzy, or cognitive evaluation based on various characteristics of the vendor location 140 as indicated in the vendor identification information included in the transaction information and verified as being from a verified vendor as discussed previously. That is, not only is it important to verify that the transaction information is coming from a source that is determined to be an authentic vendor through the vendor device evaluation discussed above, but it is also important to verify that this vendor is a specific vendor with which the account may be used, or provides goods/services with which the account may be used. Thus, the vendor verification engine 112 may evaluate other characteristics of the vendor to ensure that even though the vendor may be an authentic vendor, the account is permitted to be used with this particular vendor location 140.

For example, the vendor verification engine 112 may further evaluate the geographical location of the vendor location 140 relative to any geographical location restrictions specified in association with the account information retrieved from the account registry 118. The vendor verification engine 112 may further evaluate temporal information in the transaction information to verify whether or not the account can be used at the specified time period with the particular vendor. The vendor verification engine 112 may further verify that the vendor is a vendor that provides the types of goods/services for which the account is permitted to be used, or that the types of goods/services provided by the vendor are not restricted by the controls associated with the account information retrieved from the account registry 118. These evaluations may be weighted in a similar manner to the device information as discussed above using either a weighting logic or cognitive evaluation (e.g., using neural network evaluations).

The goods/services verification engine 114 may be provided to perform a more fine grain evaluation of the actual specific goods/services that are the subject of the transaction, as opposed to the more coarse grain evaluation based on types of goods/services discussed previously. For example, the specific identifiers of the goods/services included in the transaction information may be categorized by the goods/services verification engine 114 into one of a plurality of predetermined goods/services categories by a neural network or other classification logic of the goods/services verification engine 114. Each classified good/service may then be compared against classes of goods/services which the account information from the account registry 118 indicates the account may be used. Thus, rather than evaluating types of goods/services that the vendor in general provides, this evaluation is with respect to each actual good/service that is being purchased as part of the transaction. The result is an indication as to whether or not the transaction involves any goods/services that are restricted by controls associated with the account being utilized as part of the transaction.

The results of the various evaluations of the engines 110-114 may be input to a cognitive verification engine 130 which evaluates the combination of results from the various engines 110-114 to generate a verification response that is sent back to the source of the transaction information, e.g., POS device 146. The verification response indicates whether or not the transaction is verified and can be completed by the vendor at the vendor location 140 via the source device, e.g., POS device 146. The cognitive verification engine 130, for example, determines a probability or confidence that the user 160 is an authorized user of the account, the vendor is an authorized vendor and the vendor characteristics indicate that the account can be used to complete transactions with this vendor or vendor location, and that the goods/services that are the subject of the transaction are goods/services for which the account may be used to obtain such goods/services. Assuming that these verifications pass, the transaction is verified by the cognitive verification engine 130 and a corresponding response is sent to the POS device 146 which then completes the transaction with the user 160. If one or more of these verifications do not pass, then the transaction may be denied or rejected.

In some cases, a notification or response may be sent back with a qualified approval of the transaction. For example, if the vendor is authorized and the goods/services are authorized, but the user's identity cannot be verified based on the devices 162-166 associated with the user 160, then a qualified approval may be sent back instructing an operator of the POS device 146 to obtain further verification information for verifying the identity of the user, e.g., requesting that the user present a government issued id, valid phone number, entry of a password, or other information that uniquely identifies the authorized user of the account. Assuming such additional information is obtained and verified, then the transaction may be permitted to complete at the POS device 146. If such additional information is not obtained and verified, then the transaction may be denied or rejected.

In some cases, if the transaction is not verified as being eligible for completion at the POS device 146, and depending on the reason for the denial of the transaction, appropriate notifications may be sent to the vendor device and one or more computing/communication devices associated with the guardian, authorized user, financial institution providing the account, or the like. For example, a notification may be sent to the appropriate personnel, based on the particular implementation, to inform them of the potential identity theft or unauthorized attempt to use the account. For example, a guardian may be informed that a dependent has tried to use the account with an unauthorized vendor, or to obtain unauthorized goods/services.

Thus, the mechanisms of the illustrative embodiments provide automated cognitive evaluations of transaction information with regard to the user, vendor, and goods/services so as to ensure that controls put in place by a guardian or other oversight entity are enforced in transactions engaged in by a dependent individual. Such mechanisms reduce instances of fraud, identity theft, and further help guardians enforce the intentions and goals associated with the establishment of the account on behalf of the dependent.

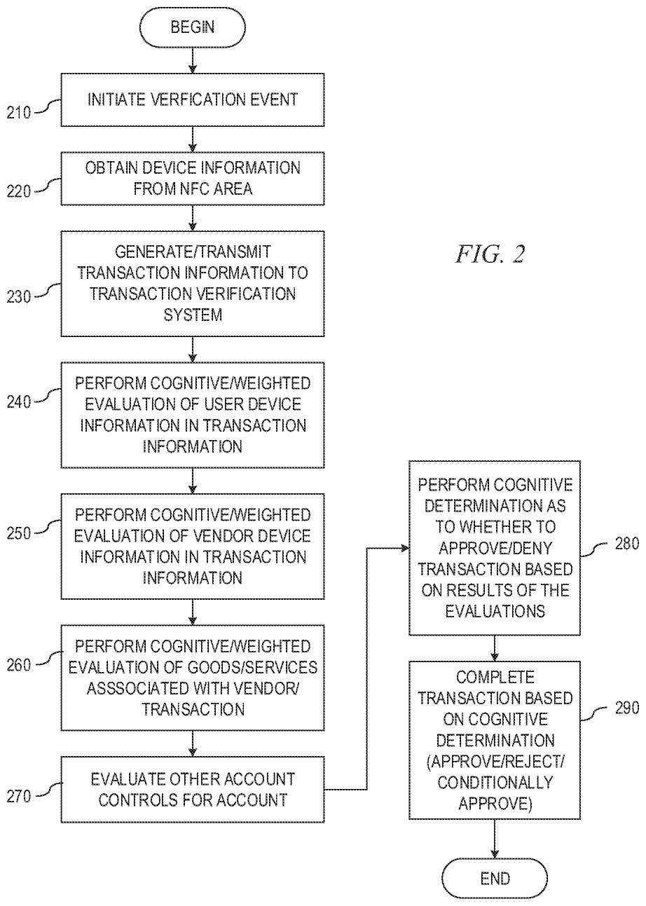

FIG. 2 is a flowchart outlining an example overall operation for transaction verification in accordance with one illustrative embodiment. As shown in FIG. 2, the operation starts by initiating, at a computing device, such as a POS device, associated with a vendor, a verification event, e.g., a transaction (step 210). The computing device, or other data communication device associated with the computing device, then performs a short range wireless communication interrogation of devices within a short range of the computing device initiating the verification event, and gathers the corresponding user device information associated with a user involved in the verification event, and potentially other devices that are within a NFC area or region around the computing device that is the source of the transaction information (step 220). The gathered device information is combined with account information, vendor information, and goods/services information to form transaction information that is transmitted to the transaction verification system for verification (step 230).

The transaction verification system receives the transaction information an performs a cognitive or weighted verification of the user device information present in the transaction information, filtering out any other device information for other devices present in the NFC area (step 240). For example, the user registry 116 may specify for the authorized user(s) associated with the account being used, as identified by the account information in the account registry 118, which user devices are registered trusted devices that can be used to verify an authorized user's identity, with each device having an assigned weight value. Alternatively, a cognitive computing system may be trained to weigh the various matching devices as described previously. For example, the user registry 116 may store, or the cognitive computing system may associate, with each trusted device a value between 1 and 100, which may be based on the mobility of the device and the historical usage of the device. For example, a weight of a fitness tracker may be set to 30 because the fitness tracker is extremely mobile, but could be taken by someone other than the user. However, the fitness tracker may have been at 4 of the last 5 verified transaction events. Additionally, a wireless speaker in the user's home is given a weight of 50 because it is not mobile, but has only been in 1 of the last 5 verified transaction events.

In some embodiments, the weight of a device may be increased the more times the device is present and/or used during a verification event (e.g., transaction, etc.). For example, because the fitness tracker has been present at 4 of the last 5 verified transactions, the user verification engine 110 may increase the weight to 50 because it is assumed the fitness tracker is a trusted device that is usually near the verified user. In some embodiments, the user verification engine 110 and/or user registry 116 may identify devices that are present during a verification event but have never been verified by a user and the user verification engine 110/user registry 116, and thus, may give these devices no weight (e.g., marking the devices as noise), e.g., the clerk's smart watch.

The weighted evaluation and/or cognitive evaluation may combine the weights associated with the various devices to generate a weighted evaluation of the probability or confidence that the combination of devices specified in the transaction information identify an authorized user of the account. In some embodiments, any statistical combination of the weights may be used (e.g., averaging, adding, etc.) or any cognitive evaluation of the device information may be utilized. Moreover, the weighted or cognitive evaluation may further compare the resulting confidence score or probability determination against a predetermined threshold value to determine if a sufficient minimum level of probability or confidence is achieved to indicate that the user is an authorized user of the account information to complete the transaction.

The transaction verification system further performs a cognitive or weighted verification of the vendor device information present in the transaction information to verify the vendor (step 250). The transaction verification system further evaluates the types of goods/services that are the subject of the transaction, the types of goods/services provided by the vendor, and/or the vendor itself against account controls associated with the account (step 260). Other account controls, such as geographical region, monetary amounts, temporal limitations, and the like may be verified as well (step 270).

The results of the various verifications are provided to a cognitive evaluation engine which then determines whether to verify the transaction or not (step 280). Based on the results of the determination whether to verify the transaction or not, the transaction is completed (step 290). The completion of the transaction may involved approval of the transaction to be completed with the user at the originating computing device, the rejection of the transaction, the conditional approval of the transaction, and may further involve the sending of appropriate notifications to computing devices/communication devices of persons to which such notifications are to be provided, e.g., guardian, financial institution, authorized user, or the like. The operation then terminates.

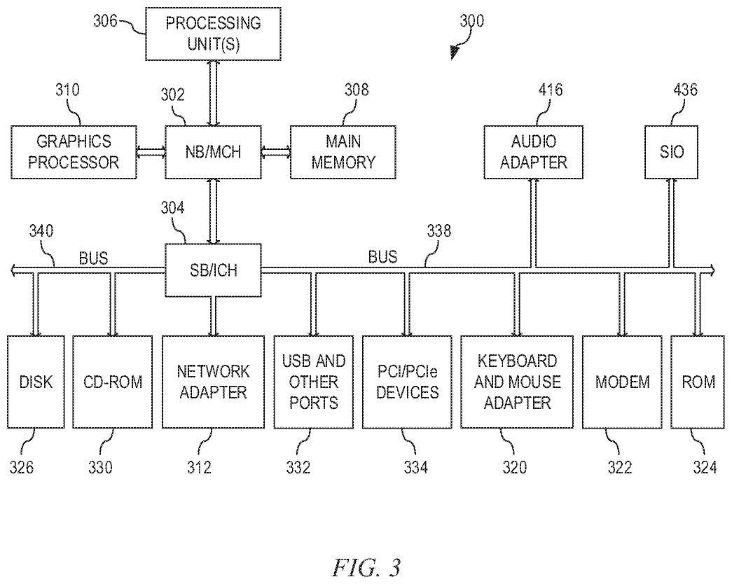

As is apparent from the above description, the illustrative embodiments provide an improved computer tool for verifying transactions. Thus, the illustrative embodiments may be utilized in many different types of data processing environments. In order to provide a context for the description of the specific elements and functionality of the illustrative embodiments, FIGS. 3-5 are provided hereafter as example environments in which aspects of the illustrative embodiments may be implemented. It should be appreciated that FIGS. 3-5 are only examples and are not intended to assert or imply any limitation with regard to the environments in which aspects or embodiments of the present invention may be implemented. Many modifications to the depicted environments may be made without departing from the spirit and scope of the present invention.

The mechanisms of the illustrative embodiments may utilize specifically configured computing devices, or data processing systems, in these various environments to perform the operations for performing cognitive transaction verification, such as described in accordance with one or more of the illustrative embodiments set forth above. These computing devices, or data processing systems, may comprise various hardware elements which are specifically configured, either through hardware configuration, software configuration, or a combination of hardware and software configuration, to implement one or more of the systems/subsystems described herein.

FIG. 3 is a block diagram of just one example data processing system in which aspects of the illustrative embodiments may be implemented. Data processing system 300 is an example of a computer, such as server computing device in which one or more of the elements of the transaction verification system 100 in FIG. 1 may be implemented. For example, computer usable code or instructions implementing the processes and aspects of the illustrative embodiments of the present invention may be located and/or executed by the data processing system 300 so as to achieve the operation, output, and external effects of the illustrative embodiments as described herein.

In the depicted example, data processing system 300 employs a hub architecture including north bridge and memory controller hub (NB/MCH) 302 and south bridge and input/output (I/O) controller hub (SB/ICH) 304. Processing unit 306, main memory 308, and graphics processor 310 are connected to NB/MCH 302. Graphics processor 310 may be connected to NB/MCH 302 through an accelerated graphics port (AGP).

In the depicted example, local area network (LAN) adapter 312 connects to SB/ICH 304. Audio adapter 316, keyboard and mouse adapter 320, modem 322, read only memory (ROM) 324, hard disk drive (HDD) 326, CD-ROM drive 330, universal serial bus (USB) ports and other communication ports 332, and PCI/PCIe devices 334 connect to SB/ICH 304 through bus 338 and bus 340. PCI/PCIe devices may include, for example, Ethernet adapters, add-in cards, and PC cards for notebook computers. PCI uses a card bus controller, while PCIe does not. ROM 324 may be, for example, a flash basic input/output system (BIOS).

HDD 326 and CD-ROM drive 330 connect to SB/ICH 304 through bus 340. HDD 326 and CD-ROM drive 330 may use, for example, an integrated drive electronics (IDE) or serial advanced technology attachment (SATA) interface. Super I/O (SIO) device 336 may be connected to SB/ICH 304.

An operating system runs on processing unit 306. The operating system coordinates and provides control of various components within the data processing system 300 in FIG. 3. As a client, the operating system may be a commercially available operating system such as Microsoft® Windows 10° or the like. An object-oriented programming system, such as the Java™ programming system, may run in conjunction with the operating system and provides calls to the operating system from Java™ programs or applications executing on data processing system 200. Various virtual machines (VMs) and virtual machine management (VMM) mechanisms may also be provided for implementing elements of the illustrative embodiments.

As a server, data processing system 300 may be, for example, an IBM eServer™ System p° computer system, Power™ processor based computer system, or the like, running the Advanced Interactive Executive (AIX®) operating system or the LINUX® operating system. Data processing system 300 may be a symmetric multiprocessor (SMP) system including a plurality of processors in processing unit 306. Alternatively, a single processor system may be employed.

Instructions for the operating system, the object-oriented programming system, and applications or programs are located on storage devices, such as HDD 326, and may be loaded into main memory 308 for execution by processing unit 306. The processes for illustrative embodiments of the present invention may be performed by processing unit 306 using computer usable program code, which may be located in a memory such as, for example, main memory 308, ROM 324, or in one or more peripheral devices 326 and 330, for example.

A bus system, such as bus 338 or bus 340 as shown in FIG. 3, may be comprised of one or more buses. Of course, the bus system may be implemented using any type of communication fabric or architecture that provides for a transfer of data between different components or devices attached to the fabric or architecture. A communication unit, such as modem 322 or network adapter 312 of FIG. 3, may include one or more devices used to transmit and receive data. A memory may be, for example, main memory 308, ROM 324, or a cache such as found in NB/MCH 302 in FIG. 3.

As mentioned above, in some illustrative embodiments the mechanisms of the illustrative embodiments may be implemented as application specific hardware, firmware, or the like, application software stored in a storage device, such as HDD 326 and loaded into memory, such as main memory 308, for executed by one or more hardware processors, such as processing unit 306, or the like. As such, the computing device shown in FIG. 3 becomes specifically configured to implement the mechanisms of the illustrative embodiments and specifically configured to perform the operations and generate the outputs described herein with regard to the transaction verification system and methodology.

Those of ordinary skill in the art will appreciate that the hardware in FIGS. 1 and 3 may vary depending on the implementation. Other internal hardware or peripheral devices, such as flash memory, equivalent non-volatile memory, or optical disk drives and the like, may be used in addition to or in place of the hardware depicted in FIGS. 1 and 3. Also, the processes of the illustrative embodiments may be applied to a multiprocessor data processing system, other than the SMP system mentioned previously, without departing from the spirit and scope of the present invention.

Moreover, the data processing system 300 may take the form of any of a number of different data processing systems including client computing devices, server computing devices, a tablet computer, laptop computer, telephone or other communication device, a personal digital assistant (PDA), or the like. In some illustrative examples, data processing system 300 may be a portable computing device that is configured with flash memory to provide non-volatile memory for storing operating system files and/or user-generated data, for example. Essentially, data processing system 300 may be any known or later developed data processing system without architectural limitation.

As previously mentioned above, in some illustrative embodiments, the transaction verification system 100 may be implemented as part of a cloud computing system. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

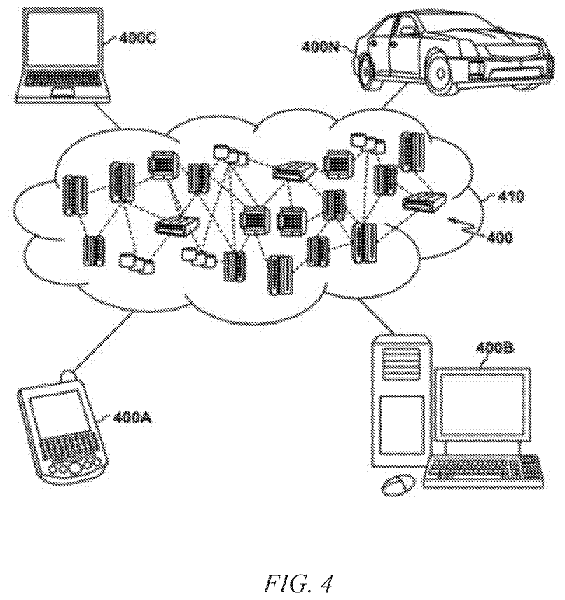

Referring now to FIG. 4, illustrative cloud computing environment 410 is depicted. As shown, cloud computing environment 410 includes one or more cloud computing nodes 400 with which local computing devices used by cloud consumers, such as, for example, personal digital assistant (PDA) or cellular telephone 400A, desktop computer 400B, laptop computer 400C, and/or automobile computer system 400N may communicate. Nodes 400 may communicate with one another. They may be grouped (not shown) physically or virtually, in one or more networks, such as Private, Community, Public, or Hybrid clouds as described hereinabove, or a combination thereof.

This allows cloud computing environment 410 to offer infrastructure, platforms and/or software as services for which a cloud consumer does not need to maintain resources on a local computing device. It is understood that the types of computing devices 400A-N shown in FIG. 4 are intended to be illustrative only and that computing nodes 400 and cloud computing environment 410 can communicate with any type of computerized device over any type of network and/or network addressable connection (e.g., using a web browser).

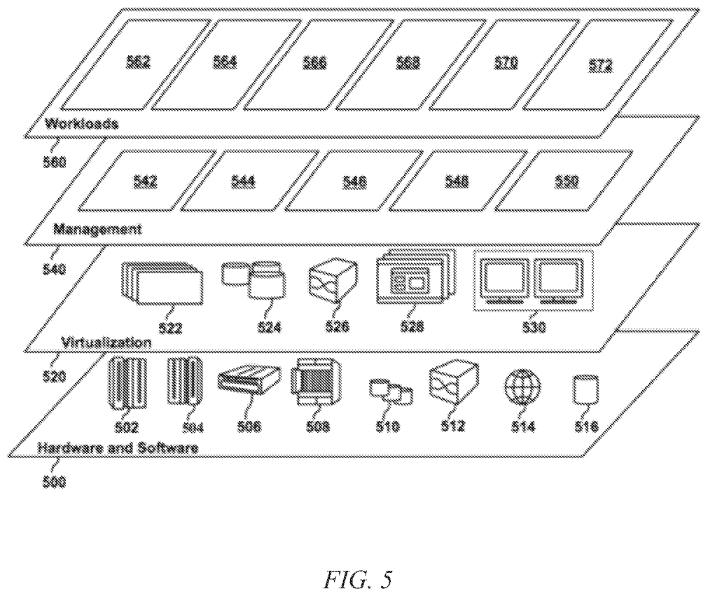

Referring now to FIG. 5, a set of functional abstraction layers provided by cloud computing environment, e.g., cloud computing environment 410 in FIG. 4, is shown. It should be understood in advance that the components, layers, and functions shown in FIG. 5 are intended to be illustrative only and embodiments of the invention are not limited thereto. As depicted below, the following layers and corresponding functions are provided.

Hardware and software layer 500 includes hardware and software components. Examples of hardware components include: mainframes 502; RISC (Reduced Instruction Set Computer) architecture based servers 504; servers 506; blade servers 508; storage devices 510; and networks and networking components 512. In some embodiments, software components include network application server software 514 and database software 516.

Virtualization layer 520 provides an abstraction layer from which the following examples of virtual entities may be provided: virtual servers 522; virtual storage 524; virtual networks 526, including virtual private networks; virtual applications and operating systems 528; and virtual clients 530.

In one example, management layer 540 may provide the functions described below. Resource provisioning 542 provides dynamic procurement of computing resources and other resources that are utilized to perform tasks within the cloud computing environment. Metering and Pricing 544 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 546 provides access to the cloud computing environment for consumers and system administrators.

Service level management 548 provides cloud computing resource allocation and management such that required service levels are met. Service Level Agreement (SLA) planning and fulfillment 550 provide pre-arrangement for, and procurement of, cloud computing resources for which a future requirement is anticipated in accordance with an SLA.

Workloads layer 560 provides examples of functionality for which the cloud computing environment may be utilized. Examples of workloads and functions which may be provided from this layer include: mapping and navigation 562; software development and lifecycle management 564; virtual classroom education delivery 566; data analytics processing 568; transaction processing 570; and transaction verification system 572. The transaction verification system 572 may comprise the various engines, logic, data structures, and the like, in the workloads layer 560 for implementing the mechanisms of the illustrative embodiments. As noted above, these mechanisms may be distributed across multiple physical and/or logical computing devices that together operate to provide the transaction verification system 572.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, wherein the at least one memory comprises instructions that are executed by the at least one processor to cause the at least one processor to be specifically configured to implement a transaction verification system, wherein the method comprises:
receiving, by the transaction verification system, transaction information from a computing device at a transaction location, wherein the transaction information comprises user device information specifying one or more user device identifiers associated with a user initiating a transaction, vendor device information specifying a plurality of vendor device identifiers in a near field area associated with the computing device, and account information for an account being used to perform the transaction;
performing, by the transaction verification system, a user device verification of the one or more user device identifiers as being associated with an authorized user of the account;
performing, by the transaction verification system, a vendor device verification of the plurality of vendor device identifiers to verify the transaction location as being an authorized vendor location with which the account may be utilized;
determining, by the transaction verification system, whether to approve or deny completion of the transaction at the computing device based on results of the user device verification and the vendor device verification; and
sending, by the transaction verification system, an output to the computing device based on the determination whether to approve or deny completion of the transaction.

2. The method of claim 1, wherein the one or more user device identifiers associated with the user initiating the transaction comprises a plurality of user device identifiers, wherein the plurality of user device identifiers are combined to generate a unique user device identifier signature that is part of the transaction information and uniquely identifies the user initiating the transaction, and wherein the plurality of vendor device identifiers are a unique vendor location signature that uniquely identifies a corresponding vendor location associated with the vendor device identifiers of the unique vendor location signature.

3. The method of claim 1, wherein performing the vendor device verification of the plurality of vendor device identifiers comprises performing at least one of a fuzzy logic or cognitive computing evaluation of the plurality of vendor device identifiers relative to stored authorized vendor device identifiers associated with the authorized vendor location to determine a probability that the transaction originates from the authorized vendor location.

4. The method of claim 3, wherein the fuzzy logic or cognitive computing evaluation comprises performing a weighted evaluation of the plurality of vendor device identifiers in which different vendor device identifiers have different associated weight values applied by artificial intelligence logic of the transaction verification system.

5. The method of claim 1, wherein determining whether to approve or deny completion of the transaction at the computing device based on results of the user device verification and the vendor device verification further comprises:
retrieving, from an authorized vendor registry data structure, vendor goods/services information for the authorized vendor location associated with the transaction location; and
comparing the vendor goods/services information for the authorized vendor location to controls associated with the account, as specified in a corresponding entry in a registered account registry data structure, wherein determining whether to approve or deny completion of the transaction at the computing device is further performed based on results of comparing the vendor goods/services information for the authorized vendor location to the controls associated with the account.

6. The method of claim 5, wherein the transaction is approved in response to the user device verification results indicating the one or more user device identifiers are associated with the authorized user of the account, the vendor device verification results indicating that the transaction location is the authorized vendor location, and the goods/services information for the authorized vendor location identify goods/services for which the account is permitted to be used as specified in the controls associated with the account.

7. The method of claim 1, wherein determining whether to approve or deny completion of the transaction at the computing device based on results of the user device verification and the vendor device verification further comprises:
retrieving, from the transaction information, specific goods/services information specifying the specific goods/services that are a target of the transaction; and
comparing the specific goods/services information to controls associated with the account, as specified in a corresponding entry in a registered account registry data structure, wherein determining whether to approve or deny completion of the transaction at the computing device is further performed based on results of comparing the specific goods/services information to the controls associated with the account.

8. The method of claim 1, wherein, in response to initiating the transaction at the transaction location, performing, by the computing device, a short range communication protocol interrogation of point of sale devices present in the near field area associated with the computing device at the transaction location and receiving, by the computing device, responsive communications from the point of sale devices specifying unique vendor device identifiers associated with the point of sale devices.

9. The method of claim 1, wherein control information associated with the account, and specified in an account registry, identifies specific vendor locations with which the account may be used to purchase goods/services, and wherein performing the vendor device verification comprises determining if the transaction location matches a specific vendor location specified in the control information associated with the account.

10. The method of claim 1, wherein the account is created by a guardian for use by a dependent person and wherein performing the user device verification of the one or more user device identifiers comprises determining if the one or more user device identifiers match user device identifiers associated with the dependent person as specified in registered device information associated with the account.

11. A computer program product comprising a computer readable storage medium having a computer readable program stored therein, wherein the computer readable program, when executed on a data processing system, causes the data processing system to implement a transaction verification system that operates to:
receive transaction information from a computing device at a transaction location, wherein the transaction information comprises user device information specifying one or more user device identifiers associated with a user initiating a transaction, vendor device information specifying a plurality of vendor device identifiers in a near field area associated with the computing device, and account information for an account being used to perform the transaction;
perform a user device verification of the one or more user device identifiers as being associated with an authorized user of the account;
perform a vendor device verification of the plurality of vendor device identifiers to verify the transaction location as being an authorized vendor location with which the account may be utilized;
determine whether to approve or deny completion of the transaction at the computing device based on results of the user device verification and the vendor device verification; and
send an output to the computing device based on the determination whether to approve or deny completion of the transaction.

12. The computer program product of claim 11, wherein the one or more user device identifiers associated with the user initiating the transaction comprises a plurality of user device identifiers, wherein the plurality of user device identifiers are combined to generate a unique user device identifier signature that is part of the transaction information and uniquely identifies the user initiating the transaction, and wherein the plurality of vendor device identifiers are a unique vendor location signature that uniquely identifies a corresponding vendor location associated with the vendor device identifiers of the unique vendor location signature.

13. The computer program product of claim 11, wherein the computer readable program further causes the transaction verification system to perform the vendor device verification of the plurality of vendor device identifiers at least by performing at least one of a fuzzy logic or cognitive computing evaluation of the plurality of vendor device identifiers relative to stored authorized vendor device identifiers associated with the authorized vendor location to determine a probability that the transaction originates from the authorized vendor location.

14. The computer program product of claim 13, wherein the fuzzy logic or cognitive computing evaluation comprises performing a weighted evaluation of the plurality of vendor device identifiers in which different vendor device identifiers have different associated weight values applied by artificial intelligence logic of the transaction verification system.

15. The computer program product of claim 11, wherein the computer readable program further causes the transaction verification system to determine whether to approve or deny completion of the transaction at the computing device based on results of the user device verification and the vendor device verification at least by:
retrieving, from an authorized vendor registry data structure, vendor goods/services information for the authorized vendor location associated with the transaction location; and
comparing the vendor goods/services information for the authorized vendor location to controls associated with the account, as specified in a corresponding entry in a registered account registry data structure, wherein determining whether to approve or deny completion of the transaction at the computing device is further performed based on results of comparing the vendor goods/services information for the authorized vendor location to the controls associated with the account.

16. The computer program product of claim 15, wherein the transaction is approved in response to the user device verification results indicating the one or more user device identifiers are associated with the authorized user of the account, the vendor device verification results indicating that the transaction location is the authorized vendor location, and the goods/services information for the authorized vendor location identify goods/services for which the account is permitted to be used as specified in the controls associated with the account.

17. The computer program product of claim 11, wherein the computer readable program further causes the transaction verification system to determine whether to approve or deny completion of the transaction at the computing device based on results of the user device verification and the vendor device verification at least by:
retrieving, from the transaction information, specific goods/services information specifying the specific goods/services that are a target of the transaction; and
comparing the specific goods/services information to controls associated with the account, as specified in a corresponding entry in a registered account registry data structure, wherein determining whether to approve or deny completion of the transaction at the computing device is further performed based on results of comparing the specific goods/services information to the controls associated with the account.

18. The computer program product of claim 11, wherein, in response to initiating the transaction at the transaction location, the computing device performs a short range communication protocol interrogation of point of sale devices present in the near field area associated with the computing device at the transaction location and receives, by the computing device, responsive communications from the point of sale devices specifying unique vendor device identifiers associated with the point of sale devices.

19. The computer program product of claim 11, wherein control information associated with the account, and specified in an account registry, identifies specific vendor locations with which the account may be used to purchase goods/services, and wherein performing the vendor device verification comprises determining if the transaction location matches a specific vendor location specified in the control information associated with the account.

20. An apparatus comprising:
at least one processor; and
at least one memory coupled to the at least one processor, wherein the at least one memory comprises instructions which, when executed by the at least one processor, cause the at least one processor to implement a transaction verification system that operates to:
receive transaction information from a computing device at a transaction location, wherein the transaction information comprises user device information specifying one or more user device identifiers associated with a user initiating a transaction, vendor device information specifying a plurality of vendor device identifiers in a near field area associated with the computing device, and account information for an account being used to perform the transaction;
perform a user device verification of the one or more user device identifiers as being associated with an authorized user of the account;
perform a vendor device verification of the plurality of vendor device identifiers to verify the transaction location as being an authorized vendor location with which the account may be utilized;
determine whether to approve or deny completion of the transaction at the computing device based on results of the user device verification and the vendor device verification; and
send an output to the computing device based on the determination whether to approve or deny completion of the transaction.
